(19) United States
(12) Patent Application Publication
(10) Pub. No.: US 2008/0172713 A1
(43) Pub. Date: Jul. 17, 2008

(54) Network Security Enforcement System

(76) Inventors: Guy-Armand Kamendje, Montreal (CA); Christian Richard, Dorval (CA)

Correspondence Address: BOND, SCHOENECK & KING, PLLC, 10 BROWN ROAD, SUITE 201, ITHACA, NY, 14850-1248, US

(21) Appl. No.: 11/570,737

(22) PCT Filed: Jun. 16, 2005
(86) PCT No.: PCT/CA2005/000949

§ 371 Date: Oct. 31, 2007

(30) Foreign Application Priority Data
Jun. 16, 2004 (CA) 2,471,055

(51) Int. Cl. G06F 21/00; H04L 9/32; G06F 17/00

(52) U.S. Cl. 726/1; 726/6

(57) ABSTRACT

A network security enforcement system includes a central location adapted to send a challenge; and at least one client station, each of the client stations being provided with an agent and being in communication with the central location. The system includes a set of S independent one-time passwords, each of the one-time passwords being associated with an index value. In response to a challenge sent by the central location to at least one of the client station, the agent returns a one-time password to the central location corresponding to the correct response otherwise the central location considers the client station insecure.

A network security policy enforcement system for workstation security parameters monitoring and network vulnerability assessment.

### TECHNICAL FIELD

The present invention pertains to computer network security and network vulnerability assessment. A new security inspection agent along with a central controller including one-time password, compression and encryption and featuring small footprint and high security technique is disclosed. Monitoring of security and configuration parameters in an IP network and autonomously triggering of pre-defined events upon deviation of the said parameters from standard values is considered in this invention. The system presented here allows for detection of security flaws that would remain undetected in conventional systems.

### BACKGROUND OF THE INVENTION

Nowadays, intrusion detection within IP networks is commonly achieved by the mean of aggressive filtering techniques that can detect possible security threats. These filtering techniques usually rely on the signature of already known network attacks or misuses for successful signature analysis or pattern matching algorithms applied to network data packets. Filtering is done at the packet level whereby each IP packet that enters the network is carefully analyzed. This approach requires the system to maintain an up-to-date database of the attacks' signatures. Due to memory scarcity the system may drop packets or shutdown computational intensive analyses. Furthermore, as the size of a network expands, this technique prohibitively burdens the network. Even worse, this technique may lead to a complete network breakdown if the processing power of the filtering engine is not judiciously chosen to cope with the increase of network traffic.

Another approach commonly implemented consists in deploying intelligent security agents in the machines present in the network. The agents reside in the machines and each agent operates only on the machine it resides in. Besides security parameter monitoring, the agents can also perform a preset given task. The intelligent agent reports the status of the monitored machine at regular intervals to the central controller. The frequency of the reports, the communication mode between the agent and the controller, etc., can be set to meet the constraints of a given network. This approach significantly reduces the network load created by the network security system. However, while reducing the traffic flow, infrequent communication between the agents and the controller degrades the overall system performance. The major drawback of this approach is the fact that the very agents can be manipulated from within the network and hence, can be easily turned into a dangerous weapon against the network by a malicious user.

### SUMMARY OF THE INVENTION

In order to solve this problem, the present invention introduces dumb agents. Dumb agents are carefully designed software programs that run on the nodes of the network. Using dumb agents significantly reduces the risk of security events triggered from within the network.

Thus, in a first aspect of the invention, there is provided network enforcement security system comprising:
a central location adapted to send a challenge;
at least one client station, each of said at least one client station being provided with an agent and being in communication with said central location;
a set of S independent one-time passwords, each of said one-time passwords being associated with an index value;
whereby, in response to a challenge sent by the central location to at least one of said at least one client station, said agent returns a one-time password to said central location corresponding to the correct response otherwise said central location considers said client station insecure.

Another aspect of the invention concerns A method for securely communicating between a central location and at least one client station, comprising the steps of:
(a) generating an initial secret and storing the same in the central location;
(b) generating a set of one-time passwords, each of the one-time passwords being associated with an index;
(c) storing a subset of the set of one time passwords in the client station;
(d) sending a challenge to the client station from the central location, wherein said challenge is an index of said subset of the set of one-time passwords;
(e) sending from the client station to the central location the one-time password associated with the index.

### BRIEF DESCRIPTION OF THE DRAWINGS

FIG. 1 depicts the network security enforcement system along with the main components which are:
The tiny dumb agent that runs on the single workstations present in the network. It comprises a communication interface a scan engine and a signature generation engine.
The central controller that maintains an up-to-date database of attacks signatures as well as the client's public keys for client signature verification. Data analysis is performed here after successful triggering of data collection request.
The security network map
The security event detection algorithm

FIG. 2 illustrates the client server communication.
Digital signature of information sent by the client is mandatory. The controller maintains a list of the public keys of the clients running in the network.
Message compression is essential for system efficiency.
The security analysis module compares incoming client configuration against the reference values stored in a database. Data preparation and presentation for the system administrator is performed here.

FIG. 3 depicts the one-time password generation process.
The user's static password is the shared secret between the client and the server. This password is usually stored on the server during user setup and is never transmitted over the network again.
The seed primarily initializes a new set of one-time passwords and hence defines the lifetime of one-time password. The seed is used on the client side for one-time password generation and for one-time password verification on the server side.
The card ID or RFID token serial number is the additional secret that the user holds. The card memory is used to store a pool of one-time passwords.

FIG. 4 depicts the memory organization of an RFID tag with a single secret stored in memory. This secret can then be used in iteratively by a cryptographic function in order to generate subsequent one-time passwords

FIG. 5 depicts the memory organization of an RFID tag with multiple secrets stored in the memory. For authentication purposes, only one of these secrets is randomly selected as a response to a challenge.

FIG. 6 presents the one-time password authentication process in a system in which the RFID tags cannot compute cryptographic functions.

FIG. 7 presents the one time password authentication process in a system in which the RFID tags are equipped with apparatus for the computation of cryptographic functions.

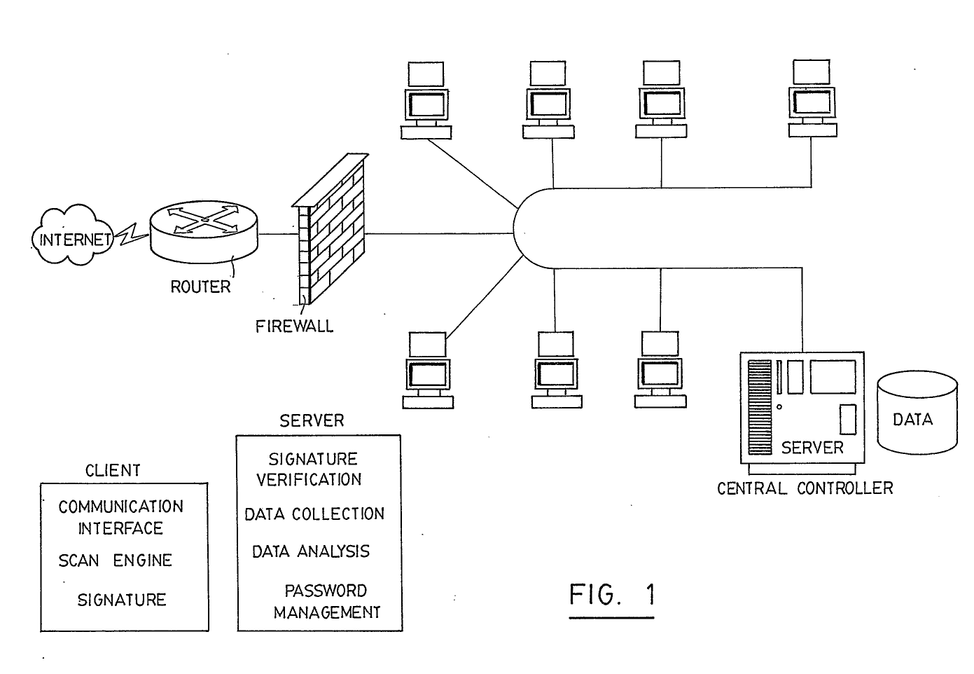

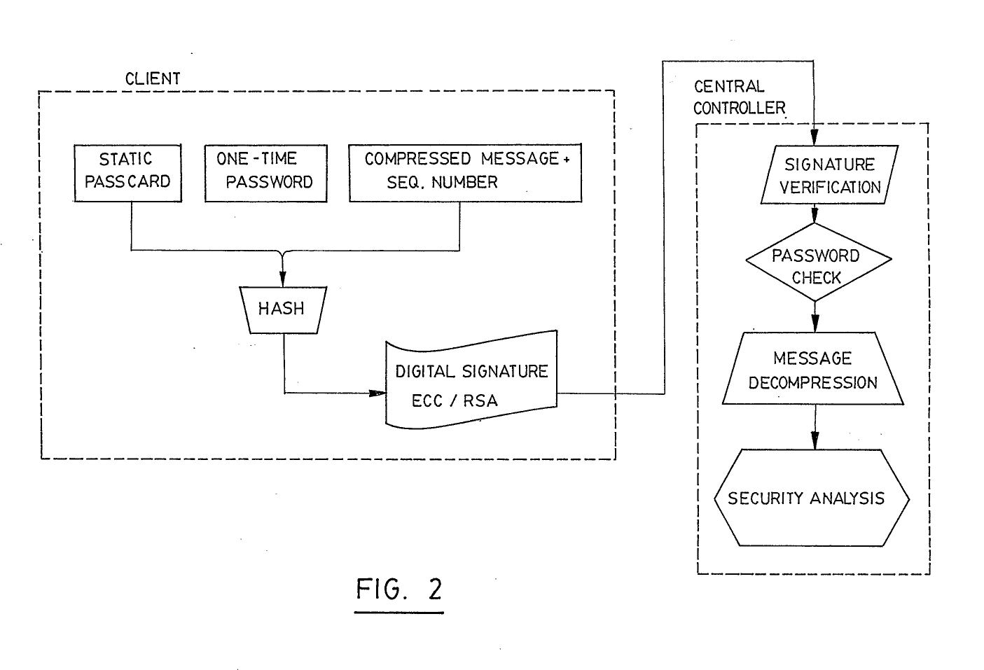

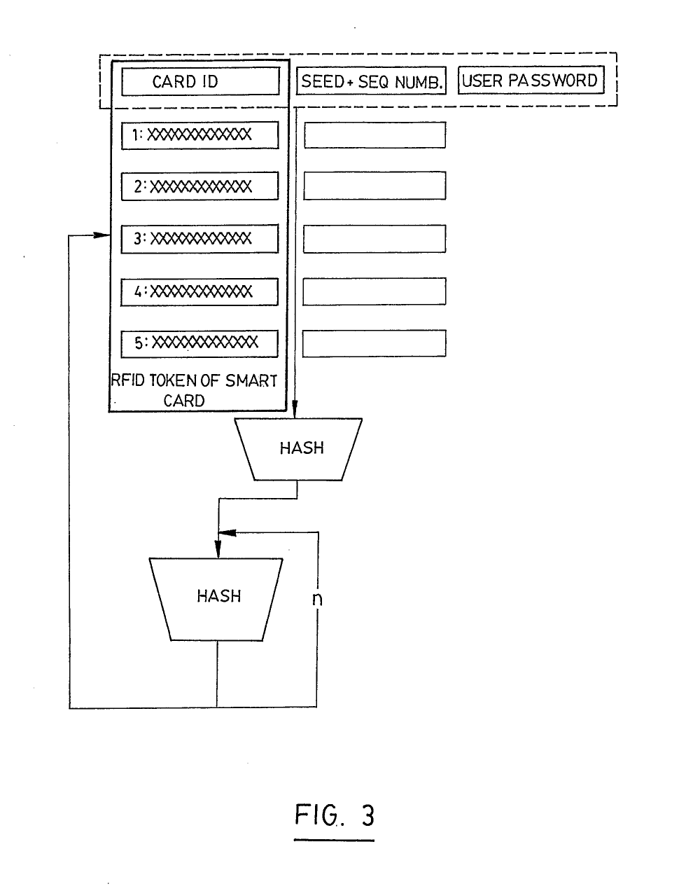

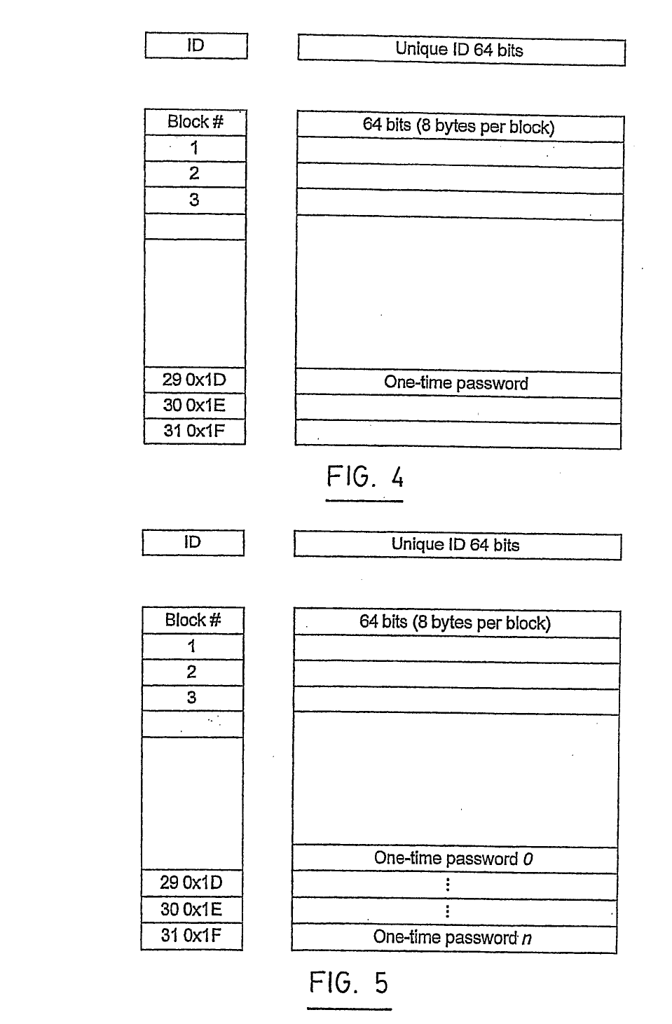

### DETAILED DESCRIPTION OF THE INVENTION

In order to be effective, it is submitted that a modern security system should implement the following tree elements.

Central controller: This may comprise firewall, anti-virus, IP filtering, network attack signature mapping and IDS functionality.

One-time-password: Prevents automatic password cracking.

Inspection client: Located in every machine. Detects breach in the first defence system and gives warning to the central controller.

This three pillar approach allows addressing network security issues in an efficient manner. Consequently, countermeasures can be tailored to withstand the attacks depending on their origin and their gravity.

Thus, the present invention concerns broadly a network security monitoring and vulnerability assessment system wherein dumb agents are used to detect any changes in the configuration of the terminal hard disk or memory. This information is transmitted to a centralized network profile analyzer that compares the configuration reported by the clients against a profile table that is constantly updated and containing all the pertinent information. The client is dumb in the sense that it can execute only a very restricted set of commands. This prevents the client from being manipulated by a malicious user from within the network. Moreover, the communication between the agent and the controller is encrypted and authenticated through the one-time password. The key aspect of this invention is a compression system that significantly alleviates the network load while maintaining a real-time communication between client and controller.

### The Dumb Agents

The agents essentially report the configuration of the node they are running on to the central controller. This report may consist of all the executables, the devices and the corresponding device drivers as well as the physical parameters of the system. In order to prevent manipulation of the client by malicious users, the central controller maintains a signature list of the clients currently active in the network. Further the client is carefully designed to execute only a very restricted set of commands that comprises regular echoes and system information disclosure. Any request that deviates from these commands is automatically filed as a possible security threat. The dumb client sends its information in a compressed and sequenced manner. A small footprint is achieved by extensive use of elliptic cryptography.

### The Central Controller

The central controller uses the agents spread over the network to obtain network information. The central controller analyzes the information provided by the software agents and decisions are taken based on some parameters provided by the system administrator. The central controller triggers the start and end of a report and consequently specifies the type of report a given client should perform.

### One-Time Password, Authentication and Encryption

The use of one-time password provides protection against passive communication eavesdropping and replay attacks when the communication between the client and the server is monitored by an attacker and information gained in this way is then used to impersonate the legitimate user. Message confidentiality and privacy is enforced by the means of encryption and digital data signature.

### The Compression System

The compression system allows for significant reduction of the network bandwidth allocated to the security management mechanism and hence allows more bandwidth to be dedicated to user and system application.

### Inventory Mechanism

One embodiment of the present invention represents an inventory system. In the said configuration, several agents are distributed in the networked item to be inventoried. Regular polling of the agents by the central controller determines the presence or absence of an item. This can be used in public access computer network such as schools or educational institution to prevent theft of peripherals such as keyboards, monitors or printers.

The information sent by the client is compressed and digitally signed using appropriate algorithms such as RSA or ECC. However, in this context, ECC based signatures should be preferred since they significantly help meeting the requirement of small foot print targeted by the invention presented here. Actually, the signature generated by the client strongly depends on both the static password provided by the user and the one-time password generated by the client and stored in the memory of a smart card or an RFID token that the user possesses.

### The Network Vulnerability Assessment System

In the event of inconsistencies between the information received from the client and the reference values stored in an appropriated database, the controller triggers an alert mechanism that informs the network administrator on the gravity of the problems encountered and the possible solutions. The alert information may be of visual or audible nature or a combination of both. Further, the information collected across the network is used to create and maintain a network vulnerability map that identifies and categorizes security deficiencies within the network. Such a map is extremely useful for the administrative staff in regard of security related future investments.

On the contrary of traditional systems, it is peculiar to the invention presented here that the client is not empowered to take action on the terminal side upon security event. Consequently, decision taking is completely deferred to the controller. In other words the client does not detect the problems. The client merely gathers pertinent information on the host and sends this information to the central controller. This subtle difference is essential to the system presented here since it prevents malicious users from manipulating the client.

### The Inventory System

In the inventory system configuration, several agents are distributed in the networked item to be inventoried. Regular polling of the agents by the central controller determines the presence or absence of an item hence triggering an alarm if required. This can be used in public access computer network such as schools or educational institution to prevent theft of peripherals such as keyboards, monitors or printers.

### The Password Management System

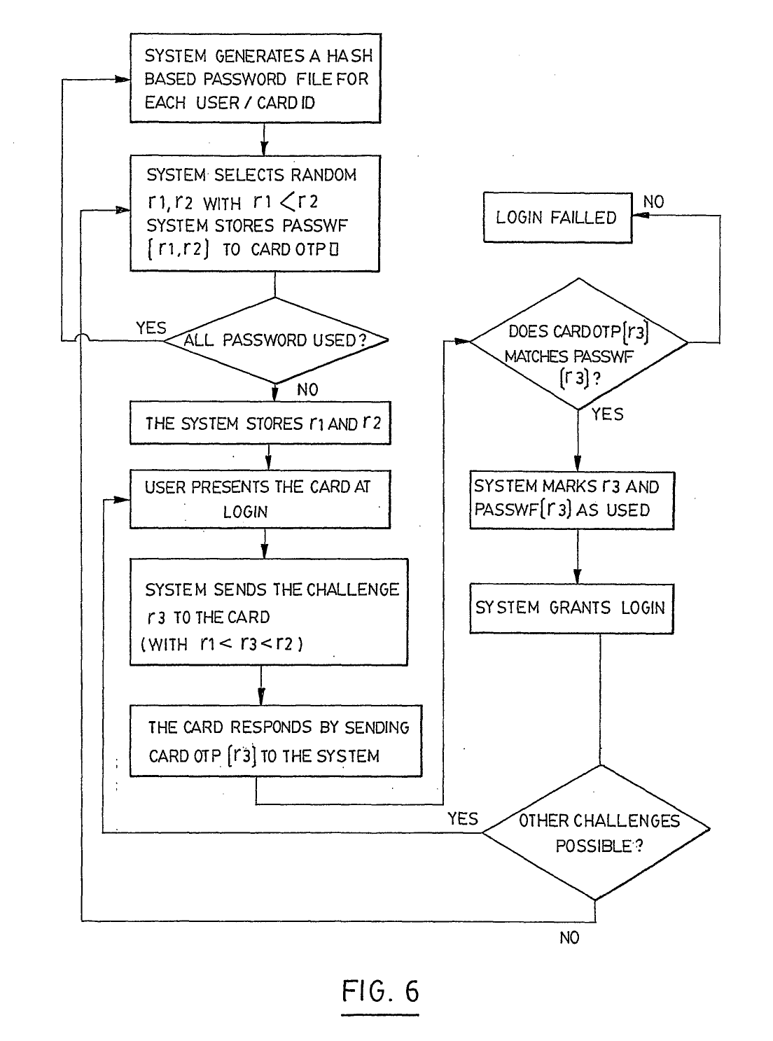

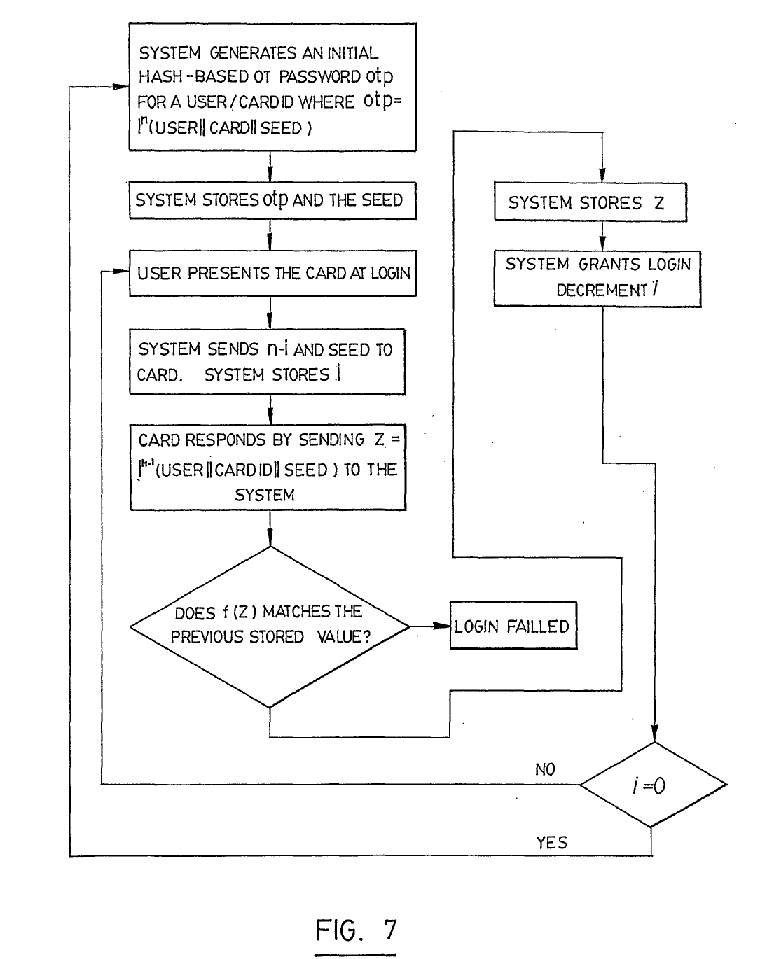

FIG. 3 depicts the one-time password generation process. The challenge (the seed) received from the network controller is combined to the user static password and to the user card ID (or RFID token serial number) in order to generate an initial secret. At this point, two cases are to be considered. In the first case the card possesses only memory for data storage and has no means for computing cryptographic functions. In the second case, we consider a card equipped with apparatus that can perform cryptographic functions.
In the first case where the RFID tag posses only memory for data storage, outgoing form the initial secret, the controller system computes a set S of independent one-time passwords that is stored in a password file on the central controller. Each one-time password is stored together with a corresponding index. Subsequently, a small subset S′ of S is stored on the card in a secure way. At login time, upon presentation of the RFID tag, the central controller issues a challenge to the tag. The challenge is merely a random index i that selects one one-time password out of the subset S′ of one-time passwords stored in the tag. As a response to the challenge, the RFID tag sends the one-time password stored in memory that corresponds to the challenge i. If this one-time password matches the one stored in the password file at index i, then authentication succeeds, otherwise authentication fails. This approach is very efficient since it does not require the user to maintain a booklet of one-time passwords. This approach is not vulnerable to over-the-shoulder attacks since the passwords are stored in the RFID tag. Further, since the one-time passwords are selected at random and the subset S′ can be chosen to be small enough to allow frequent refresh of the passwords stored in the RFID tag, a passive eavesdropper that monitors the communication between the RFID tag and the central controller will not be able to predict the next one-time password that the card will send. FIG. 6 provides an overview of this scheme.
In the second case (see FIG. 7), outgoing from the initial secret, additional passwords are generated as iterations of a cryptographic function f on the initial secret. In order to authenticate to the system, the user applies i iterations of a cryptographic functions f to the initial secret. This information is then sent to the controller. The controller verifies the correctness of the information additionally applying the cryptographic function f to the information coming from the RFID tag. The result is compared to the value of the i+1-iterations previously stored in the controller. If there is a match, authentication succeeds and the new value of together with the result of f are stored in the controller. Otherwise, authentication fails and the value of i is discarded. This system is somehow related to an S/KEY system, the difference residing in the fact that in the system we present here, computation is entirely performed on the RFID tag. Further, the tag serial number is used here to build the initial secret.

In both cases, the one-time password can subsequently be used to secure subsequent communications between the client and the central controller as depicted in FIG. 2. Doing this way, the user password is never transmitted in plain text to the central controller. A slight modification of this approach allows also for controller authentication to the client.

This represents to the inventors' knowledge the first approach for a consistent implementation of a battery-less one-time password system. Actually, the set of one-time passwords computed by the client or the server can be either based on Elliptic Curves or on the RSA scheme or on any other pseudo random function. However, RSA-based one-time passwords will hardly meet the requirement of small foot print.

As depicted in FIG. 2, the hash value of the user's static password the session one-time password and the compressed data is used as input to the digital signature algorithm. This guarantees that the one-time password significantly determines the communication stream between the client and the server for each session.

This mechanism can be used in conjunction with casino chips or other types of gaming tokens for the purpose of token authentication. In this special embodiment, the first approach should be preferred since its only requires the RFID tag to posse memory for data storage.

Although the present invention has been explained hereinabove by way of a preferred embodiment thereof, it should be pointed out that any modifications to this preferred embodiment within the scope of the appended claims is not deemed to alter or change the nature and scope of the present invention.

1. A network enforcement security system comprising:
a central location adapted to send a challenge;
at least one client station, each of said at least one client station being provided with an agent and being in communication with said central location;
a set of S independent one-time passwords, each of said one-time passwords being associated with an index value;
whereby, in response to a challenge sent by the central location to at least one of said at least one client station, said agent returns a one-time password to said central location corresponding to the correct response otherwise said central location considers said client station insecure.

2. A system according to claim 1, wherein said client station is an RFID tag, and said set of S independent one-time passwords includes a subset S′ of independent one-time passwords, each of the one-time passwords of the subset S′ being associated with an index i, said subset S′ being securely stored in said RFID tag, said challenge that is sent by the central location is a random index i and said one-time password that is returned to said central location is the one-time password corresponding to said index i.

3. A system according to claim 1, wherein said client station is adapted to calculate a one-time password based on an initial secret and on iterations of a cryptographic function f of the initial secret.

4. A system according to claim 2, wherein communication between said central controller and said client station is encrypted.

5. A system according to claim 3, wherein communication between said central controller and said client station is encrypted.

6. A system according to claim 1, wherein said agents are adapted to perform a predetermined list of commands, said list of commands being stored in said central location, whereby when said agent executes a command that is not on the list of commands, said central locations determines that the client station on which is stored the agent is compromised.

7. A system according to claim 1, wherein communication between said central location and said client station is compressed prior to being sent.

8. A system according to claim 1, wherein said central location is provided with a signature list of all of the active client stations, and wherein said central location polls said client stations to build an inventory.

9. A system according to claim 1, wherein said client station is an RFID tag, a casino chip, a computer, a hand-held device, a portable digital assistant, or a combination thereof.

10. A method for securely communicating between a central location and at least one client station, comprising the steps of:
(a) generating an initial secret and storing the same in the central location;
(b) generating a set of one-time passwords, each of the one-time passwords being associated with an index;
(c) storing a subset of the set of one time passwords in the client station;
(d) sending a challenge to the client station from the central location, wherein said challenge is an index of said subset of the set of one-time passwords;
(e) sending from the client station to the central location the one-time password associated with the index.

11. A method for securely communicating between a central location and at least one client station, comprising the steps of:
(a) generating an initial secret and storing the same in the central location and the at least one client station;
(b) sending a challenge from said central location to said at least one client station, said challenge being an index;
(c) generating a one-time password at said client station, said one-time password being an iteration of a cryptographic function on the initial secret, said iteration being related to said index;
(d) sending the one-time password to the central location.

12. A method according to claim 11, wherein said at least one client station is an RFID tag, said RFID tag further provided with a unique serial number, wherein said unique serial number is used to generate the initial secret.
